(19) United States
(12) Patent Application Publication
(10) Pub. No.: US 2026/0289524 A1
(43) Pub. Date: Sep. 24, 2026

(54) SYSTEM FOR IDENTIFYING STATE OF DEVICE

(71) Applicant: SoftBank Group Corp., Tokyo (JP)

(72) Inventor: Tetsuo FURUKAWA, Tokyo (JP)

(21) Appl. No.: 19/565,554

(22) Filed: Mar. 13, 2026

Related U.S. Application Data
(60) Provisional application No. 63/774,796, filed on Mar. 20, 2025.

(51) Int. Cl. G06Q 10/20; G06K 7/14

(52) U.S. Cl. CPC G06Q 10/20; G06K 7/1417

(57) ABSTRACT

A system that streamlines the handling of malfunction reports at a call center, wherein a user reads a two-dimensional code attached to a device using a smartphone to acquire identification information of the device. The user answers a questionnaire and takes and uploads a picture of a lamp of a network device. This data is transmitted to a server, and an AI performs analysis using image recognition technology to identify the cause of a failure.

### CROSS-REFERENCE TO RELATED APPLICATIONS

This application is based upon and claims the benefit of priority from U.S. Provisional Patent Application No. 63/774,796, filed on Mar. 20, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is to improve the efficiency of handling malfunction reports at call centers and to shorten the user's response time. In conventional call centers, when a user reports a malfunction of a device, a detailed explanation of the situation is required, and it takes a lot of time and effort for an operator to identify the problem based on that information and instruct on an appropriate countermeasure. In addition, users often spent time on telephone interactions and felt stress until the problem was resolved.

Disclosed herein is a system in which a user uses a smartphone to read a QR code (a two-dimensional code), fill out a questionnaire, and take a picture of a lamp of a network device, whereby an AI automatically identifies the cause of a failure and presents a countermeasure. This allows the user to perform temporary isolation by themselves, and can reduce the burden on the front-office operations of the call center. Furthermore, the possibility that the user can also quickly resolve the problem increases, which leads to a shortening of the response time. This system aims to reduce the man-hours of front-office operations and users, and to improve overall efficiency.

Disclosed herein is a system including the following configuration. First, the system includes a code reading unit for reading a QR code attached to a device when a user feels a malfunction. This code reading unit can scan the QR code using a mobile terminal such as a smartphone to acquire identification information of the device and access information to related data. Next, the system includes a questionnaire input unit for a user to fill out a questionnaire. This questionnaire input unit provides an interface for the user to answer basic questions regarding the malfunction, and can collect an overview of the problem.

Furthermore, the system includes an image acquisition unit for taking and uploading a picture of a lamp of a network device. This image acquisition unit transmits a picture of the lamp taken by the user to the system and provides information that visually indicates the state of the device. Following this, the system includes an analysis unit for analyzing the data of the questionnaire and the picture of the lamp. This analysis unit uses AI to fully utilize image recognition technology, analyzes the state of the lamp, and identifies the cause of the failure in combination with the data of the questionnaire.

Finally, the system includes a presentation unit for presenting a countermeasure to the user based on the analysis result. This presentation unit presents to the user a specific countermeasure corresponding to the cause of the failure identified by the AI, and provides instructions for the user to temporarily isolate and resolve the problem by themselves. This makes it possible to reduce the burden on the front-office operations of the call center and to shorten the user's response time.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example method of identifying a state of a device.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

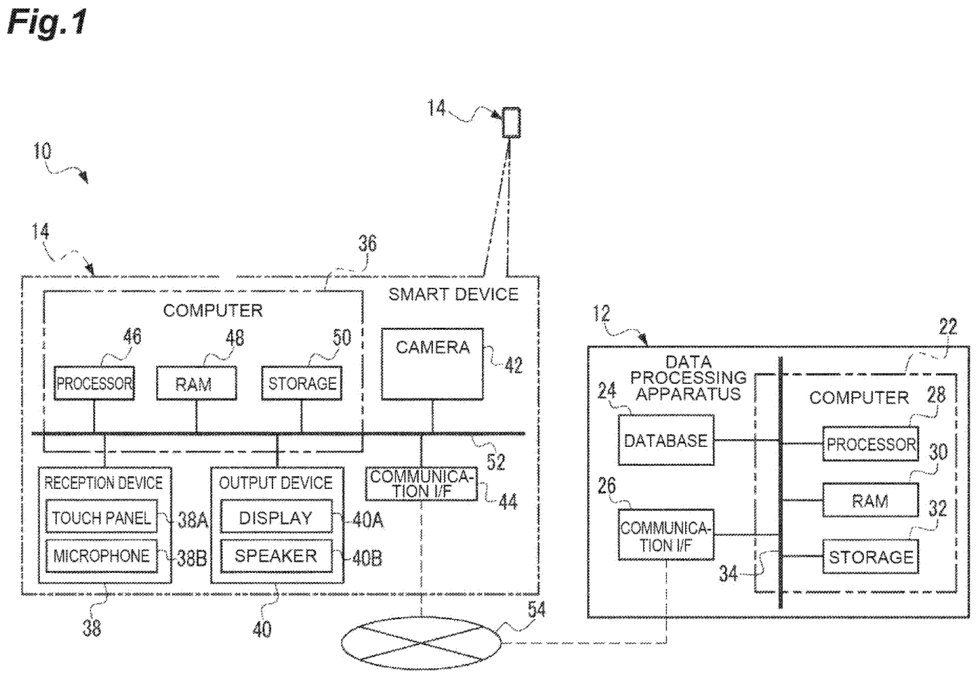

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

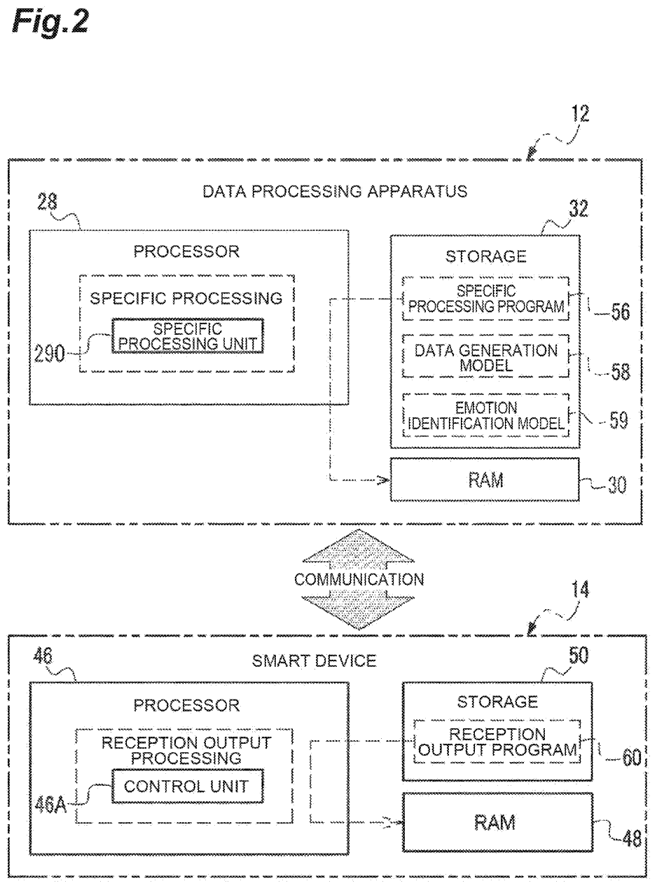

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

How each unit of the system with both a server and a terminal specifically functions will be described in detail.

First, the terminal is a mobile terminal such as a smartphone or a tablet operated by a user, and includes a code reading unit for reading a QR code. This code reading unit scans a QR code attached to a device by using a camera function built into the terminal. The QR code includes detailed information such as a serial number, a product model number, a manufacturing date, a warranty period, technical specifications, and a past maintenance history of the device. This information is securely transmitted from the terminal to the server and used for identifying the device and acquiring related data.

The code reading unit may be configured by, for example, the camera 42 of the smart device 14.

Next, a questionnaire input unit is implemented in the terminal and provides an interface for the user to answer basic questions regarding a malfunction. This interface is designed to be intuitively operated by the user, and includes detailed questions such as, for example, “Is the device powered on?”, “Is an error message displayed?”, “What kind of operation was performed?”, “When did the malfunction occur?”, and “In what kind of environment is it being used?”. By the user answering these questions, a detailed overview of the problem is collected and transmitted to the server.

The questionnaire input unit may be configured by, for example, the computer 36 (the processor 46, etc.) and the reception device 38 (the touch panel 38A, the microphone 38B, etc.) of the smart device 14.

Furthermore, the terminal is provided with an image acquisition unit, and the user takes a picture of a lamp of a network device and uploads it to the system. This image acquisition unit uses a high-resolution camera function of the terminal to clearly record the state of the lamp and transmits it to the server. For example, information is included such as whether the lamp is lit, blinking, off, or lit in a specific color. This makes it possible to visually confirm the state of the device.

The image acquisition unit may transmit, to the camera 42, a control signal for automatically setting camera parameters (ISO sensitivity, shutter speed, white balance) optimal for photographing a lamp of a device based on model information of the device identified by a QR code. For example, in order to prevent erroneous detection due to flicker of an LED, the shutter speed may be adjusted so as not to interfere with a driving frequency of the LED, or exposure may be corrected in order to accurately identify the color (red, orange, green) of the lamp in a dark place. In this way, the present system ensures analysis accuracy by actively controlling the operation of hardware (an image sensor) in accordance with the physical characteristics of a target device, rather than performing general-purpose photographing.

The image acquisition unit may be configured by, for example, the camera 42 of the smart device 14.

On the server side, an analysis unit for analyzing the data of the questionnaire and the picture of the lamp is implemented. This analysis unit uses AI to fully utilize advanced image recognition technology and analyzes the state of the lamp in detail. For example, if a blinking pattern of the lamp corresponds to a specific error code, it can be accurately identified. In addition, in combination with the data of the questionnaire, the cause of the failure is analyzed from multiple perspectives and identified. The AI performs a more accurate diagnosis by collating with a past database and referring to similar problems and solutions.

In image analysis processing by the analysis unit, a processor may execute edge detection processing and color space conversion processing (for example, conversion from RGB to HSV) in order to identify an area of a status lamp (LED, etc.) of a network device from received image data. The processor may calculate a blinking cycle (frequency) and a duty ratio (ratio of lighting time to extinguishing time) of the lamp based on a plurality of image frames or moving image data acquired in time series. An internal state of the device may be identified by collating (pattern matching) a high-speed blinking pattern (for example, blinking in units of milliseconds or a specific irregular blinking sequence) difficult to distinguish by human visual observation with signal waveform data of a “normal pattern” and a “known error pattern” stored in the database 24 in advance. This processing is not a mere comparison of images but is processing of quantifying and analyzing physical light signal characteristics, and is processing that cannot be performed by human mental activity.

The analysis unit may concatenate a feature vector (first vector) extracted from image data, a semantic feature vector (second vector) extracted by performing natural language processing (NLP) on text data of a questionnaire, and device-specific log data (third vector) acquired from a QR code, and input the concatenated data to a multilayer neural network (for example, a Transformer-based model or a Deep Neural Network). The neural network has learned a huge number of past pairs of failure cases and solutions as training data, and can output a probability score of a failure cause based on the input concatenated vector. This makes it possible to detect, with high accuracy, a complex malfunction (e.g., a state where the lamp is normal but communication settings are incorrect) that cannot be identified by a single information source.

The analysis unit may be configured by, for example, the computer 22 (the processor 28, etc.) of the data processing apparatus 12, or may be configured by the specific processing unit 290, the specific processing program 56, the data generation model 58, and the like.

Finally, the server is provided with a presentation unit for presenting a countermeasure to the user based on the analysis result. This presentation unit presents to the user a specific countermeasure corresponding to the cause of the failure identified by the AI. For example, detailed instructions such as “Please restart the power,” “Please check the cable,” “Please change the specific setting,” “Please update the firmware,” and “Please contact support” can be considered. This allows the user to temporarily isolate and quickly resolve the problem by themselves.

The presentation unit may display, on a display of the smart device 14 or the smart glasses 214, an AR (Augmented Reality) object indicating the position of a physical switch or a cable to be operated, superimposed on an image of the device in real space. A processor may track the three-dimensional shape and position and orientation of the device in real time by image recognition, and dynamically correct the display position of the AR object. When the identified cause of the failure can be resolved by a software restart or setting change, the presentation unit may be configured to transmit a direct control command (a reset signal, a firmware update command, etc.) to the device via the network 54 instead of or together with an instruction to the user, and automatically execute recovery processing. This eliminates the user's operation burden and minimizes the response time.

The presentation unit may be configured by, for example, the computer 22 (the processor 28, etc.) and the communication I/F 26 of the data processing apparatus 12, or may be configured by the specific processing unit 290, the specific processing program 56, the data generation model 58, and the like.

In this way, by the server and the terminal operating in high coordination, it becomes possible to significantly reduce the burden on the front-office operations of the call center and to shorten the user's response time. This system aims to reduce the man-hours of front-office operations and users, and to improve overall efficiency, and also contributes to the improvement of user experience.

In the present system, data communication including identification information of a device, a captured image, and a diagnosis result may be performed via a secure communication tunnel (VPN, etc.) established using a temporary encryption key (one-time token) included in a QR code. This prevents communication interception by a third party and unauthorized access (Man-in-the-middle attack) to the device during failure diagnosis. From image data transmitted for analysis, privacy information (a person's face, documents in a room, etc.) reflected in the background may be automatically detected by terminal-side edge processing before transmission, and masking (blurring processing) may be applied, thereby ensuring security while reducing the amount of data.

### System Configuration

The system includes a code reading unit, a questionnaire input unit, an image acquisition unit, an analysis unit, and a presentation unit. The code reading unit has a function of scanning a QR code attached to a device by using a camera function built into a mobile terminal such as a smartphone or a tablet operated by a user. This QR code includes detailed information such as a serial number, a product model number, a manufacturing date, a warranty period, technical specifications, and a past maintenance history of the device, and this information is securely transmitted from the terminal to the server. For example, by reading the QR code, the user can quickly identify the device and acquire related data. In addition, by scanning the QR code, the user can automatically access a dedicated diagnostic application, whereby the diagnostic process is smoothly started.

The questionnaire input unit provides an interface for the user to answer basic questions regarding a malfunction. This interface is designed to be intuitively operated by the user, and includes detailed questions such as, for example, “Is the device powered on?”, “Is an error message displayed?”, “What kind of operation was performed?”, “When did the malfunction occur?”, and “In what kind of environment is it being used?”. By the user answering these questions, a detailed overview of the problem is collected and transmitted to the server. The questionnaire input unit transmits the user's input to the server in real time, enabling quick analysis. In addition, the information input by the user is collated with past data and used as basic data for referring to similar problems and solutions.

The image acquisition unit has a function for a user to take a picture of a lamp of a network device and upload it to the system. This image acquisition unit uses a high-resolution camera function of the terminal to clearly record the state of the lamp and transmits it to the server. For example, information is included such as whether the lamp is lit, blinking, off, or lit in a specific color. This makes it possible to visually confirm the state of the device. The image acquisition unit automatically optimizes the image taken by the user and transmits it to the server in a format suitable for analysis. In addition, the uploading of the image is performed quickly and efficiently, minimizing user operations.

The analysis unit has a function for analyzing the data of the questionnaire and the picture of the lamp. This analysis unit uses AI to fully utilize advanced image recognition technology and analyzes the state of the lamp in detail. For example, if a blinking pattern of the lamp corresponds to a specific error code, it can be accurately identified. In addition, in combination with the data of the questionnaire, the cause of the failure is analyzed from multiple perspectives and identified. The AI performs a more accurate diagnosis by collating with a past database and referring to similar problems and solutions. The analysis unit enables real-time data processing and provides quick feedback.

The presentation unit has a function for presenting a countermeasure to the user based on the analysis result. This presentation unit presents to the user a specific countermeasure corresponding to the cause of the failure identified by the AI. For example, detailed instructions such as “Please restart the power,” “Please check the cable,” “Please change the specific setting,” “Please update the firmware,” and “Please contact support” can be considered. This allows the user to temporarily isolate and quickly resolve the problem by themselves. The presentation unit provides visual and auditory feedback to the user, so that the user can easily understand and execute the instructions.

As a specific example of a prompt sentence to be read into a generative AI, an instruction such as “Design a system that scans a QR code to acquire device information, answers a questionnaire to provide an overview of a problem, takes and uploads a picture of a lamp, and has an AI analyze it to identify the cause of a failure and present a countermeasure” can be considered. This prompt sentence clearly indicates how each unit of the system cooperates and what kind of service is provided to the user.

### Implementation Steps

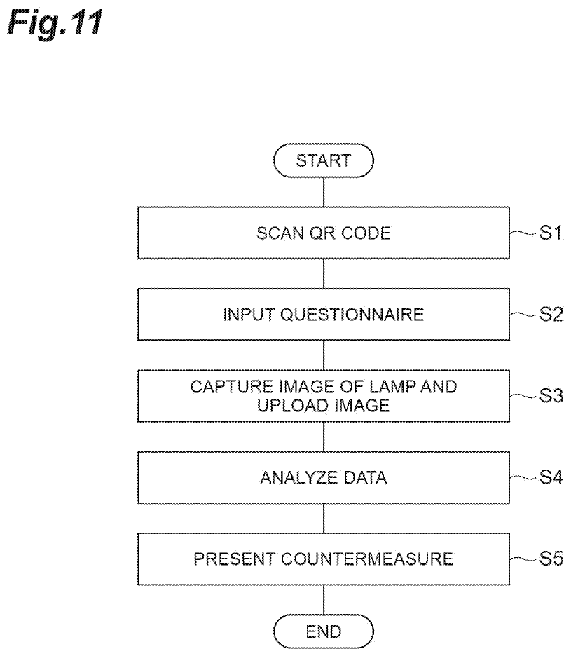

### Step 1: Scanning of QR Code (Refer to Step S1 of FIG. 11)

A user scans a QR code attached to a device using a mobile terminal such as a smartphone or a tablet. This QR code includes detailed information such as a serial number, a product model number, a manufacturing date, a warranty period, technical specifications, and a past maintenance history of the device. By scanning the QR code, the user can quickly identify the device and acquire related data. In addition, by scanning the QR code, the user can automatically access a dedicated diagnostic application, whereby the diagnostic process is smoothly started.

### Step 2: Input of Questionnaire (Refer to Step S2 of FIG. 11)

The user answers basic questions regarding a malfunction described in a questionnaire through an interface on the terminal. This interface is designed to be intuitively operated by the user, and includes detailed questions such as, for example, “Is the device powered on?”, “Is an error message displayed?”, “What kind of operation was performed?”, “When did the malfunction occur?”, and “In what kind of environment is it being used?”. By the user answering these questions, a detailed overview of the problem is collected and transmitted to the server.

### Step 3: Taking and Uploading a Picture of a Lamp (Refer to Step S3 of FIG. 11)

The user takes a picture of a lamp of a network device using a high-resolution camera of the terminal. This image acquisition unit clearly records the state of the lamp and transmits it to the server. For example, information is included such as whether the lamp is lit, blinking, off, or lit in a specific color. The image is automatically optimized and transmitted to the server in a format suitable for analysis.

### Step 4: Analysis of Data (Refer to Step S4 of FIG. 11)

On the server side, the data of the questionnaire and the picture of the lamp are analyzed by an AI. This analysis unit uses AI to fully utilize advanced image recognition technology and analyzes the state of the lamp in detail. For example, if a blinking pattern of the lamp corresponds to a specific error code, it can be accurately identified. In addition, in combination with the data of the questionnaire, the cause of the failure is analyzed from multiple perspectives and identified. As a specific example of a prompt sentence to be read into a generative AI, an instruction such as “Design a system that scans a QR code to acquire device information, answers a questionnaire to provide an overview of a problem, takes and uploads a picture of a lamp, and has an AI analyze it to identify the cause of a failure and present a countermeasure” can be considered.

### Step 5: Presentation of Countermeasure (Refer to Step S5 of FIG. 11)

Based on the analysis result, the server presents a specific countermeasure to the user. This presentation unit presents to the user a specific countermeasure corresponding to the cause of the failure identified by the AI. For example, detailed instructions such as “Please restart the power,” “Please check the cable,” “Please change the specific setting,” “Please update the firmware,” and “Please contact support” can be considered. This allows the user to temporarily isolate and quickly resolve the problem by themselves. The presentation unit provides visual and auditory feedback to the user, so that the user can easily understand and execute the instructions.

### Specific Use Case

For example, consider a case where a situation occurs in a certain household in which the Internet connection suddenly becomes unstable. In this household, since there is a possibility that a malfunction has occurred in a network device, the user first scans a QR code attached to the device using a smartphone. This QR code includes information such as a serial number, a product model number, technical specifications, and a past maintenance history of the device, and this information is transmitted to the server.

Next, the user answers a questionnaire through a dedicated application on the smartphone. This questionnaire includes questions such as “When did the Internet connection become unstable?”, “What kind of operation was performed?”, “Is a similar problem occurring on other devices?”, and “Is the device powered on?”. By the user answering these questions, a detailed overview of the problem is collected.

After that, the user confirms the state of a lamp of the network device and takes a picture of it using the camera of the smartphone. The state of the lamp includes, for example, being lit, blinking, off, or lit in a specific color, and this information is transmitted to the server. The server analyzes the transmitted data of the questionnaire and the picture of the lamp using an AI to identify the cause of the failure.

The AI analyzes the state of the lamp by fully utilizing image recognition technology, and performs a multifaceted analysis in combination with the data of the questionnaire. For example, if a blinking pattern of the lamp corresponds to a specific error code, it is accurately identified, and similar problems and solutions are referred to by collating with a past database. Based on the analysis result, the server presents a specific countermeasure to the user.

As the presented countermeasure, instructions such as “Please restart the power,” “Please check the cable,” “Please change the specific setting,” “Please update the firmware,” and “Please contact support” can be considered. This allows the user to temporarily isolate and quickly resolve the problem by themselves.

As a specific example of a prompt sentence to be read into a generative AI, an instruction such as “Design a system that scans a QR code to acquire device information, answers a questionnaire to provide an overview of a problem, takes and uploads a picture of a lamp, and has an AI analyze it to identify the cause of a failure and present a countermeasure” can be considered. This prompt sentence clearly indicates how each unit of the system cooperates and what kind of service is provided to the user.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

A system for streamlining failure diagnosis and repair response for equipment and facilities in a logistics center is provided. This system includes a QR code reading unit, a questionnaire input unit, an image acquisition unit, an analysis unit, and a presentation unit, and each unit functions in cooperation.

First, the QR code reading unit has a function of scanning a QR code attached to various equipment and facilities in a logistics center using a smartphone or a tablet. This QR code includes detailed information such as a serial number, a product model number, a manufacturing date, a maintenance history, and technical specifications of the equipment, and this information is securely transmitted from the terminal to the server. For example, QR codes are attached to equipment such as a belt conveyor, a forklift, a pallet rack, a transfer robot, and a packaging machine, and a worker can quickly identify the equipment and acquire related data by scanning this. By scanning the QR code, the user can automatically access a dedicated diagnostic application, whereby the diagnostic process is smoothly started.

Next, the questionnaire input unit provides an interface for a worker to answer basic questions regarding a malfunction of the equipment. This interface is designed to be intuitively operated by the user, and includes detailed questions such as, for example, “Is there an abnormal noise?”, “Is the operation slow?”, “Is an error message displayed?”, “What kind of operation was performed?”, “When did the malfunction occur?”, and “In what kind of environment is it being used?”. By the worker answering these questions, a detailed overview of the problem is collected and transmitted to the server. The questionnaire input unit enables real-time data transmission and supports quick analysis. In addition, the information input by the user is collated with past data and used as basic data for referring to similar problems and solutions.

Furthermore, the image acquisition unit has a function for a worker to take a picture indicating the state of the equipment and upload it to the system. This image acquisition unit uses a high-resolution camera function of the terminal to clearly record the state of the equipment and transmits it to the server. For example, looseness of a belt of a belt conveyor, an overheating state of a motor, a positional deviation of a sensor, a trace of an oil leak, and damage to a part can be visually confirmed. The image acquisition unit automatically optimizes the image taken by the user and transmits it to the server in a format suitable for analysis. In addition, the uploading of the image is performed quickly and efficiently, minimizing user operations.

The analysis unit has a function for analyzing the data of the questionnaire and the picture of the lamp. This analysis unit uses AI to fully utilize advanced image recognition technology and analyzes the state of the equipment in detail. For example, it can identify the degree of belt looseness, a temperature abnormality of a motor, a malfunction of a sensor, a drop in oil pressure, and an abnormality of an electronic component. In addition, in combination with the data of the questionnaire, the cause of the failure is analyzed from multiple perspectives and identified. The AI performs a more accurate diagnosis by collating with a past database and referring to similar problems and solutions. The analysis unit enables real-time data processing and provides quick feedback.

Finally, the presentation unit has a function for presenting a countermeasure to the worker based on the analysis result. This presentation unit presents to the worker a specific countermeasure corresponding to the cause of the failure identified by the AI. For example, instructions such as “Please adjust the tension of the belt,” “Please cool the motor,” “Please recalibrate the sensor,” “Please replace the part,” and “Please adjust the oil pressure” can be considered. This allows the worker to quickly resolve the problem and minimize the downtime of the equipment. The presentation unit provides visual and auditory feedback to the user, so that the user can easily understand and execute the instructions.

In this way, by the server and the terminal operating in high coordination, it becomes possible to improve the operational efficiency of the logistics center. The system is expected to improve the productivity of the logistics center by reducing the burden on workers and enabling a quick response.

### System Configuration

The system includes a QR code reading unit, a questionnaire input unit, an image acquisition unit, an analysis unit, and a presentation unit. The QR code reading unit has a function of scanning a QR code attached to various equipment and facilities in a logistics center using a smartphone or a tablet. This QR code includes detailed information such as a serial number, a product model number, a manufacturing date, a maintenance history, and technical specifications of the equipment, and this information is securely transmitted from the terminal to the server. For example, QR codes are attached to equipment such as a belt conveyor, a forklift, a pallet rack, a transfer robot, and a packaging machine, and a worker can quickly identify the equipment and acquire related data by scanning this. By scanning the QR code, the user can automatically access a dedicated diagnostic application, whereby the diagnostic process is smoothly started.

The questionnaire input unit provides an interface for a worker to answer basic questions regarding a malfunction of the equipment. This interface is designed to be intuitively operated by the user, and includes detailed questions such as, for example, “Is there an abnormal noise?”, “Is the operation slow?”, “Is an error message displayed?”, “What kind of operation was performed?”, “When did the malfunction occur?”, and “In what kind of environment is it being used?”. By the worker answering these questions, a detailed overview of the problem is collected and transmitted to the server. The questionnaire input unit enables real-time data transmission and supports quick analysis. In addition, the information input by the user is collated with past data and used as basic data for referring to similar problems and solutions.

The image acquisition unit has a function for a worker to take a picture indicating the state of the equipment and upload it to the system. This image acquisition unit uses a high-resolution camera function of the terminal to clearly record the state of the equipment and transmits it to the server. For example, looseness of a belt of a belt conveyor, an overheating state of a motor, a positional deviation of a sensor, a trace of an oil leak, and damage to a part can be visually confirmed. The image acquisition unit automatically optimizes the image taken by the user and transmits it to the server in a format suitable for analysis. In addition, the uploading of the image is performed quickly and efficiently, minimizing user operations.

The analysis unit has a function for analyzing the data of the questionnaire and the picture of the lamp. This analysis unit uses AI to fully utilize advanced image recognition technology and analyzes the state of the equipment in detail. For example, it can identify the degree of belt looseness, a temperature abnormality of a motor, a malfunction of a sensor, a drop in oil pressure, and an abnormality of an electronic component. In addition, in combination with the data of the questionnaire, the cause of the failure is analyzed from multiple perspectives and identified. The AI performs a more accurate diagnosis by collating with a past database and referring to similar problems and solutions. The analysis unit enables real-time data processing and provides quick feedback.

The presentation unit has a function for presenting a countermeasure to the worker based on the analysis result. This presentation unit presents to the worker a specific countermeasure corresponding to the cause of the failure identified by the AI. For example, instructions such as “Please adjust the tension of the belt,” “Please cool the motor,” “Please recalibrate the sensor,” “Please replace the part,” and “Please adjust the oil pressure” can be considered. This allows the worker to quickly resolve the problem and minimize the downtime of the equipment. The presentation unit provides visual and auditory feedback to the user, so that the user can easily understand and execute the instructions.

As a specific example of a prompt sentence to be read into a generative AI, an instruction such as “Design a system that scans a QR code to acquire device information, answers a questionnaire to provide an overview of a problem, takes and uploads a picture of a lamp, and has an AI analyze it to identify the cause of a failure and present a countermeasure” can be considered. This prompt sentence clearly indicates how each unit of the system cooperates and what kind of service is provided to the user.

### Implementation Steps

### Step 1: Scanning of QR Code

In a logistics center, a worker scans a QR code attached to a device using a smartphone or a tablet. This QR code includes detailed information such as a serial number, a product model number, a manufacturing date, a maintenance history, and technical specifications of the device. By scanning the QR code, the worker can quickly identify the device and acquire related data. For example, QR codes are attached to equipment such as a belt conveyor, a forklift, and a pallet rack, and by scanning this, the worker can automatically access a dedicated diagnostic application.

### Step 2: Input of Questionnaire

The worker answers a questionnaire regarding a malfunction of the equipment through an interface on the terminal. This questionnaire includes detailed questions such as “Is there an abnormal noise?”, “Is the operation slow?”, “Is an error message displayed?”, “What kind of operation was performed?”, “When did the malfunction occur?”, and “In what kind of environment is it being used?”. By the worker answering these questions, a detailed overview of the problem is collected and transmitted to the server.

### Step 3: Taking and Uploading a Picture of Equipment State

The worker takes a picture indicating the state of the equipment using a high-resolution camera of the terminal. This image includes looseness of a belt of a belt conveyor, an overheating state of a motor, a positional deviation of a sensor, a trace of an oil leak, and damage to a part. The taken image is uploaded to the system and transmitted to the server. The image is automatically optimized and transmitted in a format suitable for analysis.

### Step 4: Analysis of Data

On the server side, the data of the questionnaire and the picture of the equipment are analyzed by an AI. This analysis unit uses AI to fully utilize advanced image recognition technology and analyzes the state of the equipment in detail. For example, it can identify the degree of belt looseness, a temperature abnormality of a motor, a malfunction of a sensor, a drop in oil pressure, and an abnormality of an electronic component. The AI performs a more accurate diagnosis by collating with a past database and referring to similar problems and solutions. As a specific example of a prompt sentence to be read into a generative AI, an instruction such as “Design a system that scans a QR code to acquire device information, answers a questionnaire to provide an overview of a problem, takes and uploads a picture of the equipment, and has an AI analyze it to identify the cause of a failure and present a countermeasure” can be considered.

### Step 5: Presentation of Countermeasure

Based on the analysis result, the server presents a specific countermeasure to the worker. This presentation unit presents to the worker a specific countermeasure corresponding to the cause of the failure identified by the AI. For example, instructions such as “Please adjust the tension of the belt,” “Please cool the motor,” “Please recalibrate the sensor,” “Please replace the part,” and “Please adjust the oil pressure” can be considered. This allows the worker to quickly resolve the problem and minimize the downtime of the equipment. The presentation unit provides visual and auditory feedback to the user, so that the user can easily understand and execute the instructions.

### Specific Use Case

For example, consider a case where a situation occurs in a logistics center in which a belt conveyor suddenly stops. In such a case, a worker first scans a QR code attached to the belt conveyor using a smartphone. This QR code includes detailed information such as a serial number, a product model number, a manufacturing date, a maintenance history, and technical specifications of the belt conveyor, and this information is transmitted to the server. By scanning the QR code, the worker can automatically access a dedicated diagnostic application.

Next, the worker answers a questionnaire on the application. This questionnaire includes detailed questions such as “Is there an abnormal noise?”, “Is the operation slow?”, “Is an error message displayed?”, “What kind of operation was performed?”, “When did the malfunction occur?”, and “In what kind of environment is it being used?”. By the worker answering these questions, a detailed overview of the problem is collected.

After that, the worker takes a picture indicating the state of the belt conveyor and uploads it to the server through the application. For example, looseness of the belt, an overheating state of a motor, a positional deviation of a sensor, a trace of an oil leak, and damage to a part can be visually confirmed. This picture becomes important data for analysis by the AI.

On the server side, the AI performs analysis by combining the data of the questionnaire and the picture. The AI identifies the degree of belt looseness, a temperature abnormality of a motor, a malfunction of a sensor, a drop in oil pressure, and an abnormality of an electronic component by fully utilizing image recognition technology. In addition, by collating with a past database and referring to similar problems and solutions, the cause of the failure is analyzed from multiple perspectives.

Based on the analysis result, the server presents a specific countermeasure to the worker. For example, instructions such as “Please adjust the tension of the belt,” “Please cool the motor,” “Please recalibrate the sensor,” “Please replace the part,” and “Please adjust the oil pressure” can be considered. This allows the worker to quickly resolve the problem and minimize the downtime of the belt conveyor.

As a specific example of a prompt sentence to be read into a generative AI, an instruction such as “Design a system that scans a QR code to acquire device information, answers a questionnaire to provide an overview of a problem, takes and uploads a picture of the equipment, and has an AI analyze it to identify the cause of a failure and present a countermeasure” can be considered. This prompt sentence clearly indicates how each unit of the system cooperates and what kind of service is provided to the user.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

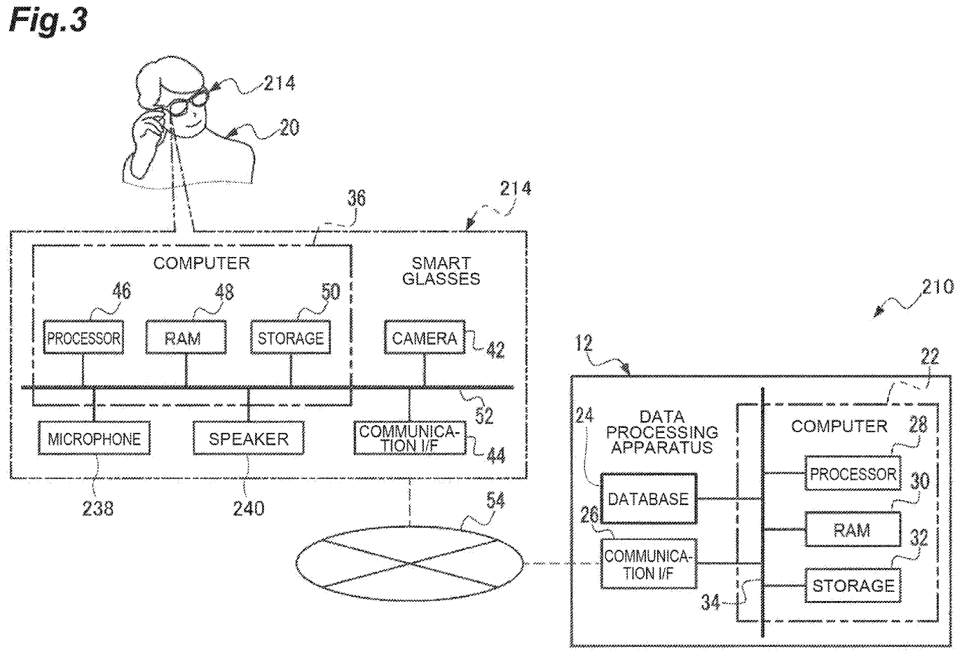

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

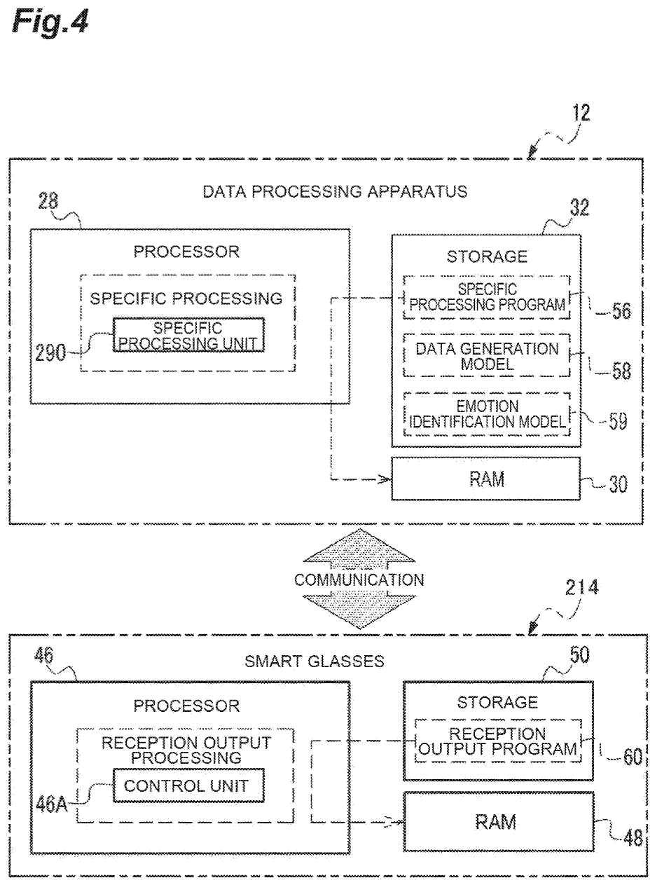

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

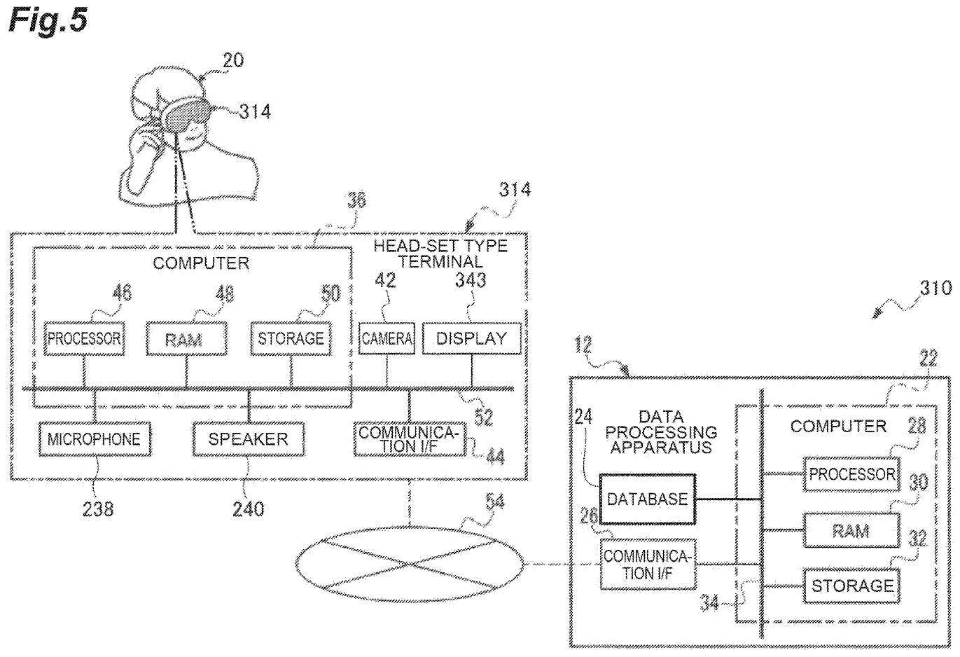

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

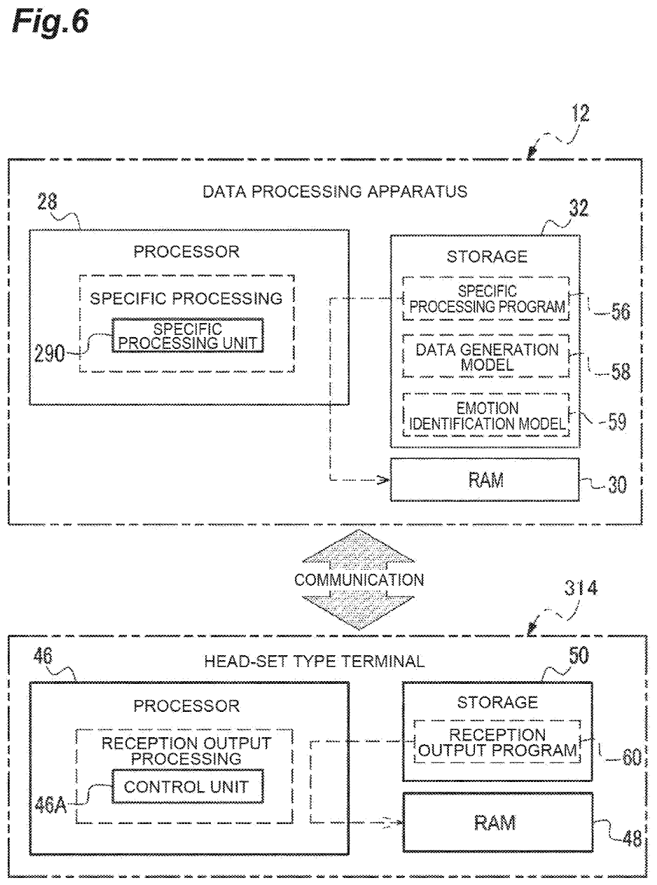

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

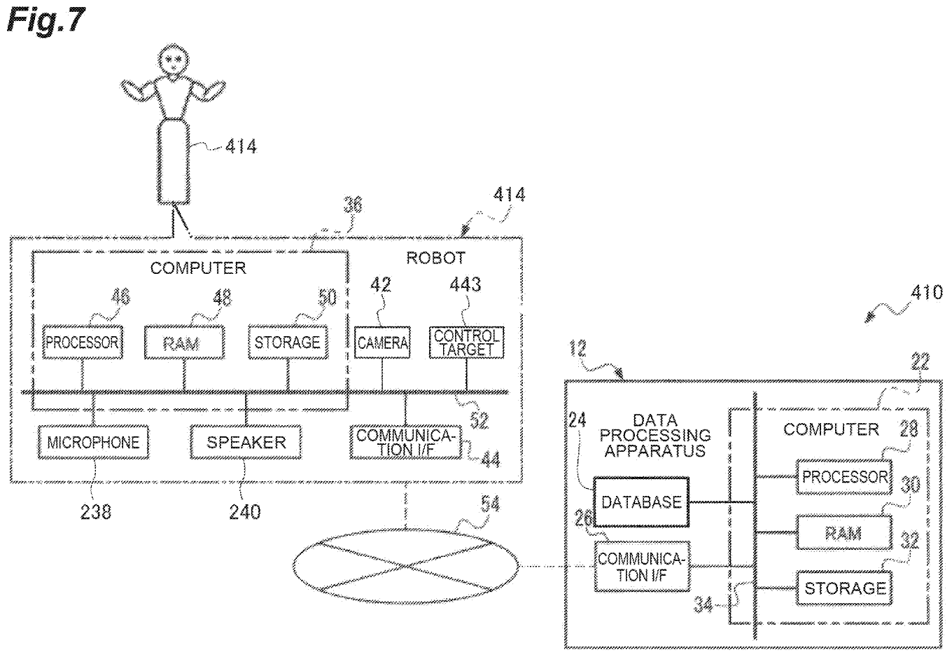

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

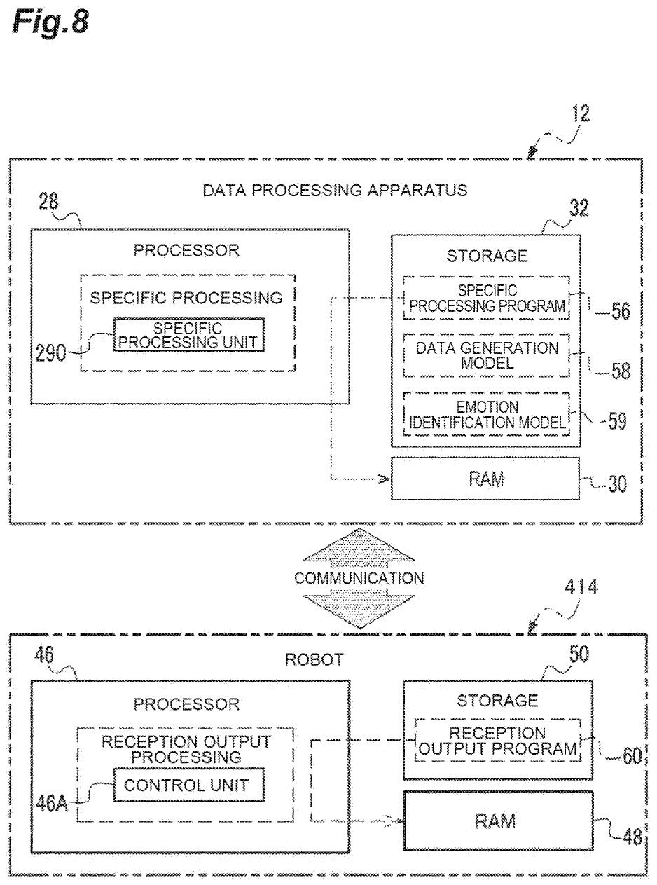

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

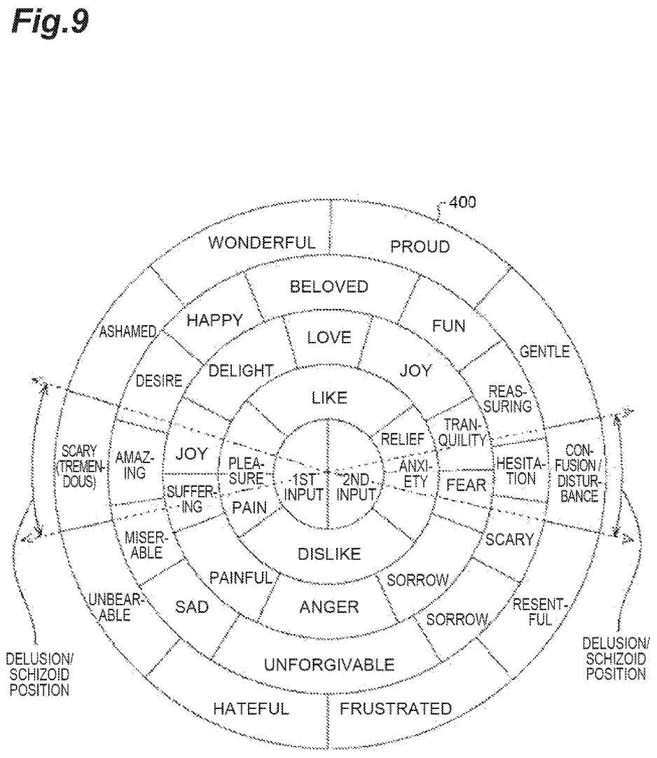

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

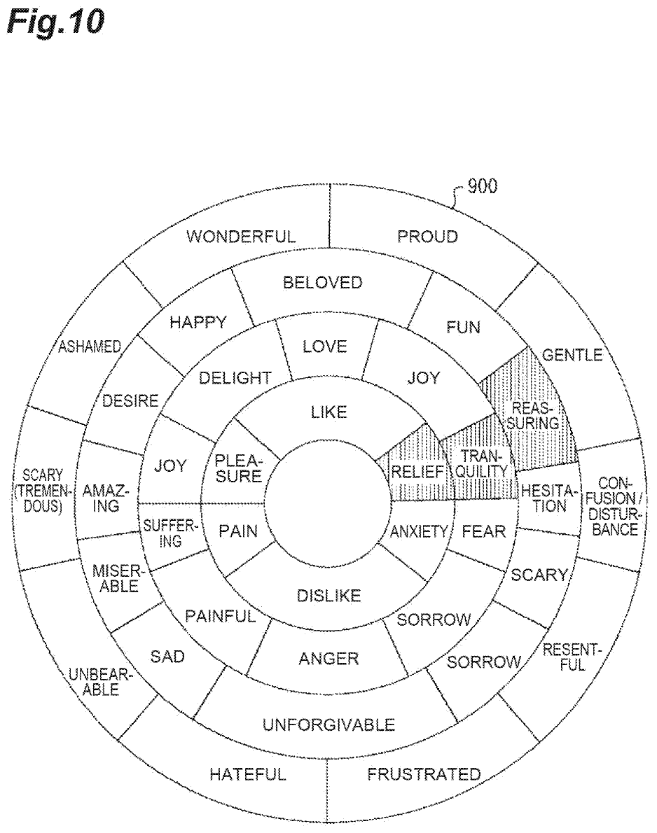

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a QR code reading unit, a questionnaire input unit, an image acquisition unit, an analysis unit, and a presentation unit. The QR code reading unit scans a QR code attached to various equipment and facilities in a logistics center using a smartphone or a tablet to acquire detailed information such as identification information, a manufacturing date, a maintenance history, and technical specifications of the equipment. The questionnaire input unit provides an interface for a worker to answer basic questions regarding a malfunction of the equipment and collects a detailed overview of the problem. The image acquisition unit has a function for the worker to take a picture indicating the state of the equipment and upload it to a server, and visually confirms looseness of a belt of a belt conveyor, an overheating state of a motor, a positional deviation of a sensor, and the like. The analysis unit analyzes data of the questionnaire and the image in combination using an AI to identify the cause of a failure. The presentation unit presents a specific countermeasure to the worker based on the analysis result, and enables quick problem resolution.

In some examples, the QR code reading unit can quickly identify the equipment and acquire related data by scanning a QR code attached to each piece of equipment in the logistics center, and enables access to a dedicated diagnostic application. The QR code includes information such as a serial number, a product model number, technical specifications, and a past maintenance history of the equipment, and this information is transmitted to a server and used for identifying the equipment.

In some examples, the analysis unit performs a multifaceted analysis by combining data of the questionnaire and the image by fully utilizing image recognition technology using an AI, and identifies the cause of a failure. The AI performs a more accurate diagnosis by collating with a past database and referring to similar problems and solutions, and presents a specific countermeasure to a worker. This allows the worker to quickly resolve the problem and minimize the downtime of the equipment.

An example system for identifying a state of a device may include circuitry. The circuitry may be configured to: activate a diagnostic application on a terminal in response to reading a two-dimensional code attached to a device; identify the state of the device by analyzing user input data to a questionnaire of the diagnostic application and a captured image of the device; and present a countermeasure to the user based on an identified malfunction of the device.

In some examples, the two-dimensional code may include identification information of the device and related information of the device.

In some examples, identifying a cause of the malfunction of the device may be identified by analyzing the captured image using an AI using image recognition technology.

An example method of identifying a state of a device may include: activating a diagnostic application on a terminal in response to reading a two-dimensional code attached to the device; identifying the state of the device by analyzing user input data to a questionnaire of the diagnostic application and a captured image of the device; and presenting a countermeasure to the user based on an identified malfunction of the device.

What is claimed is:

1. A system for identifying a state of a device, the system comprising circuitry,
wherein the circuitry is configured to:
activate a diagnostic application on a terminal in response to reading a two-dimensional code attached to the device;
identify the state of the device by analyzing user input data to a questionnaire of the diagnostic application and a captured image of the device; and
present a countermeasure to the user based on an identified malfunction of the device.

2. The system according to claim 1, wherein the two-dimensional code includes identification information of the device and related information of the device.

3. The system according to claim 1, wherein a cause of the malfunction of the device is identified by analyzing the captured image using an AI using image recognition technology.

4. A method of identifying a state of a device, the method comprising:
activating a diagnostic application on a terminal in response to reading a two-dimensional code attached to the device;
identifying the state of the device by analyzing user input data to a questionnaire of the diagnostic application and a captured image of the device; and
presenting a countermeasure to the user based on an identified malfunction of the device.
